(19) United States
(12) Patent Application Publication
(10) Pub. No.: US 2015/0136250 A1
(43) Pub. Date: May 21, 2015

(54) DIRT DISCHARGE STRUCTURE AND CONTAINER WITH THE DIRT DISCHARGE STRUCTURE

(71) Applicant: SHINKONG IECOFUN CORPORATION, TAIPEI (TW)

(72) Inventor: Jung-Kun CHEN, TAIPEI (TW)

(21) Appl. No.: 14/537,348

(22) Filed: Nov. 10, 2014

(30) Foreign Application Priority Data
Nov. 11, 2013 (TW) 102140897

(51) Int. Cl. A01K 63/00

(52) U.S. Cl. CPC A01K 63/006
USPC 137/550

(57) ABSTRACT

The present invention relates to a dirt discharge structure, comprising: a base including a slanted plate extending inwardly from a peripheral edge of a top of the base toward a bottom of the base, an arcuate plate extending inwardly from an inner peripheral edge of the slanted plate toward the bottom of the base, and a discharging hole provided at the bottom of the arcuate plate; a barrier plate provided on the top of the base, and a plurality of the through-holes provided on the barrier plate; and a tube kit including: a first tube provided beneath the arcuate plate and connected to the discharging hole, a second tube connected to one side of the first tube, and a rotary valve connected to the first tube used for communicating with the first tube and the second tube. The present invention further comprises a container with the dirt discharge structure.

### FIELD OF THE INVENTION

The present invention relates to a dirt discharge structure and a container with the dirt discharge structure.

### BACKGROUND OF THE INVENTION

During breeding fishes in an aquarium, the residual feed and the waste of fishes are inevitable in the aquarium, and the filth (the residual feed and the waste of fishes) are usually deposited at the bottom of the aquarium. Further, the feed and the waste of the fishes will pollute the water in the aquarium. For instance, the chemical substance (such as nitrous acid) contained in the waste of the fishes will harm the fishes.

Therefore, it is known that some base structures of the aquarium have been used for discharging the aforesaid filth. For example, the cross-sectional views shown in FIG. 1A and FIG. 1B illustrate that such base plates are utilized to deposit the filth (the feed and the waste of the fishes); when the deposition of the filth reaches a certain level or when it is time to replace the water, the user can discharge the water in the aquarium via the discharging hole of the base plate and the filth deposited on the base plate can be taken away by the flow of the water. However, with such kinds of flat base plates 90, 91 as shown in FIG. 1A and FIG. 1B, it is not easy for the filth to be moved together with the water, and thus the filth still deposits on the base plate 90, 91 even though the water which is polluted has been discharged. Therefore, when adding clean water to the aquarium, the clean water will be polluted immediately by the filth still deposited on the base plate 90, 91.

Furthermore, please refer to the following two websites: (1) http://ppt.cc/S˜j5; and (2) http://youtube/z4BK8_d3I7Y. These websites show an aquarium called as “NoClean Desktop Aquarium” and such aquarium can discharge foul water by siphon action. When in use, users can discharge the foul water by adding clean water to the aquarium wherein the water quantity of the added water is equal to the water quantity of the discharged water; however, such aquarium still cannot completely discharge the deposited filth.

Hence, one important purpose of the present invention is to solve the problem regarding filth deposition.

### SUMMARY OF THE INVENTION

In order to solve the aforesaid problem of filth deposition, the present invention provides a dirt discharge structure, comprising: a base including a slanted plate extending inwardly from a peripheral edge of a top of the base toward a bottom of the base, an arcuate plate extending inwardly from an inner peripheral edge of the slanted plate toward the bottom of the base, and a discharging hole provided at the bottom of the arcuate plate; a barrier plate provided on the top of the base, and a plurality of the through-holes provided on the barrier plate; and a tube kit including: a first tube provided beneath the arcuate plate and connected to the discharging hole, a second tube connected to one side of the first tube, and a rotary valve connected to the first tube used for communicating with the first tube and the second tube.

In the aforesaid dirt discharge structure, the present invention further comprises an intake kit provided in the base and extending through the slanted plate and the barrier plate.

In the aforesaid dirt discharge structure, the intake kit comprises a housing provided in the base and extending through the slanted plate and the barrier plate; an intake valve provided within the house; an air stone provided on the intake valve; and an intake tube connected to the bottom of the housing.

In the aforesaid dirt discharge structure, a plurality of far-infrared powders is intermixed into the base and the barrier plate.

The present invention further provides a container having a dirt discharge structure as stated above, wherein the dirt discharge structure is provided at the bottom of the container; wherein the container comprises a cover at the top of the container; and wherein the cover further comprises at least one plant pot, at least one solar energy LED and at least one opening.

The present invention further comprises an L-shaped wall board, the board comprising a flat panel and a side plate, the side plate connected to the flat panel vertically, wherein the bottom of the base of the dirt discharge structure is connected to the flat panel.

In the aforesaid wall board, the flat panel comprises a plurality of protrusions and the protrusions are fitted into the bottom of the base.

In the aforesaid wall board, the side plate comprises a plurality of hanging holes.

By utilizing the aforesaid structures of the present invention, the filth deposited in the base can be completely discharged through the discharging hole, and thus the water added later into the container will not be polluted by the filth.

### BRIEF DESCRIPTION OF THE DRAWINGS

FIG. 1A is a cross-sectional view of an embodiment of a conventional dirt discharge structure;

FIG. 1B is a cross-sectional view of another embodiment of a conventional dirt discharge structure;

FIG. 2A is an exploded view of the base of the dirt discharge structure of the present invention;

FIG. 2B is an exploded view (in another view angle) of the base of the dirt discharge structure of the present invention;

FIG. 3 is an exploded view of the base of the dirt discharge structure of the present invention, wherein the base includes an intake kit;

FIG. 4 is a perspective view of the assembled base of the dirt discharge structure of the present invention;

FIG. 5 is a perspective view of a container having the dirt discharge structure of the present invention;

FIG. 6 is a partial cross-sectional view taken along line VI-VI of FIG. 5;

FIG. 7 illustrates a schematic drawing showing the embodiment of FIG. 6 when in use;

FIG. 8 is a perspective view of a container having the dirt discharge structure of the present invention, wherein the container is used for breeding fishes and aquatic plants;

FIG. 9 is a perspective view showing that the container and the wall board of the present invention have not yet connected with each other;

FIG. 10 shows that the container of FIG. 9 and the wall board of FIG. 9 are connected with each other; and

FIG. 11 is a partial cross-sectional view taken along line XI-XI of FIG. 5.

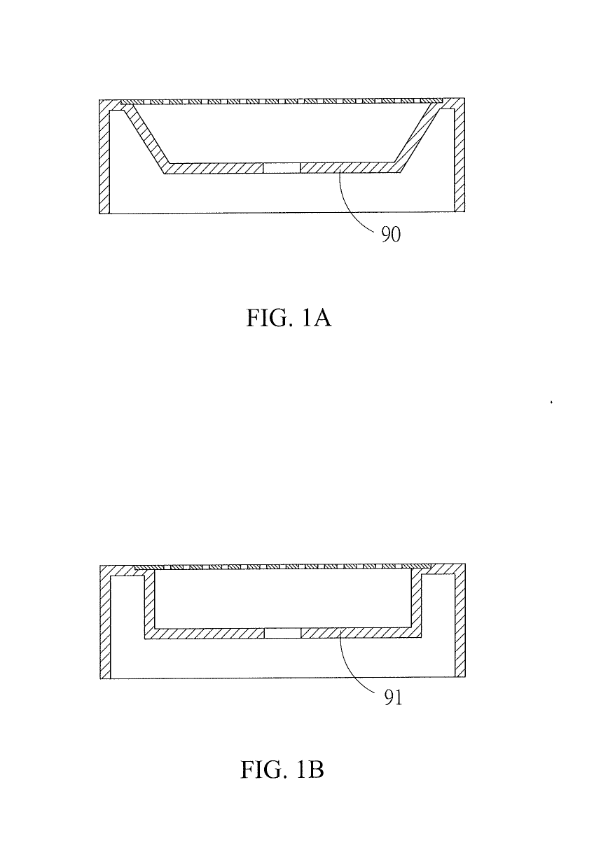

### DETAILED DESCRIPTION OF THE INVENTION

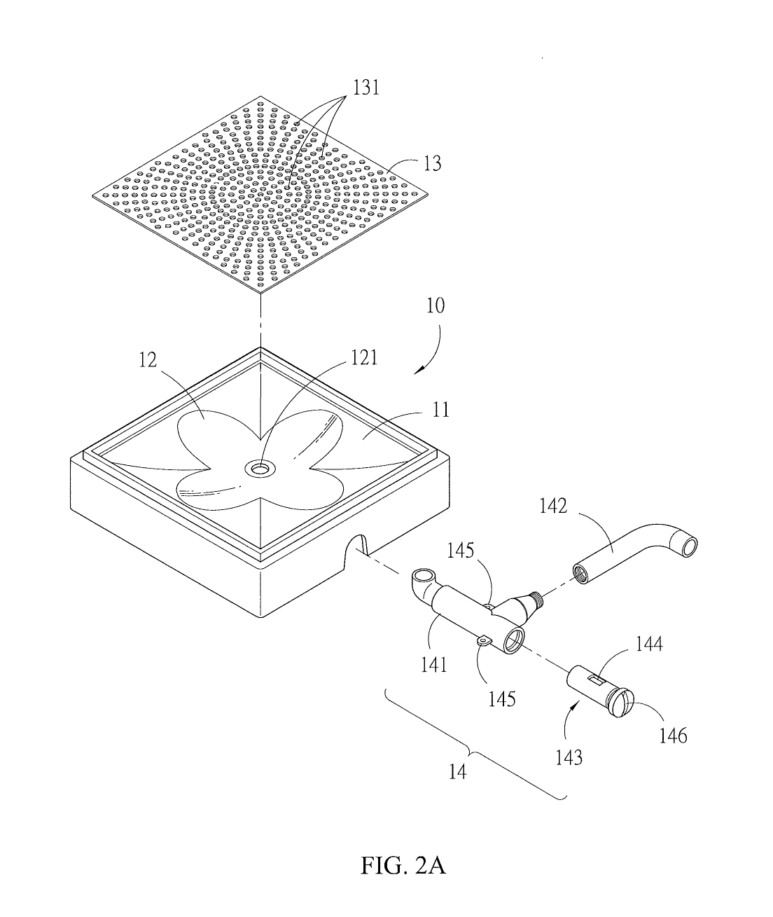

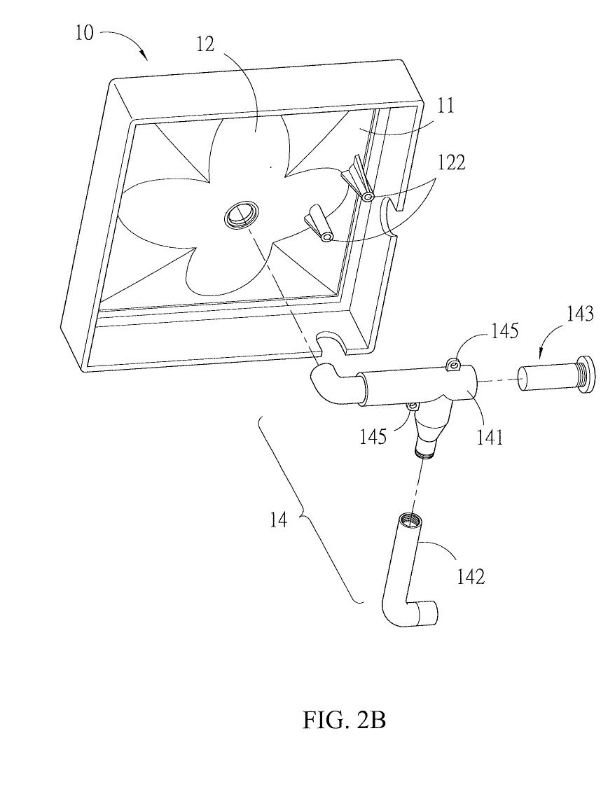

As shown in the exploded views in FIG. 2A and FIG. 2B, the present invention provides a dirt discharge structure, comprising: a base 10 including a slanted plate 11 extending inwardly from a peripheral edge of a top of the base 10 toward a bottom of the base 10, an arcuate plate 12 extending inwardly from an inner peripheral edge of the slanted plate 11 toward the bottom of the base 10, and a discharging hole 121 provided at the bottom of the arcuate plate 12; a barrier plate 13 provided on the top of the base 10, and a plurality of the through-holes 131 provided on the barrier plate 13; and a tube kit 14 including: a first tube 141 provided beneath the arcuate plate 12 and connected to the discharging hole 121, a second tube 142 connected to one side of the first tube 141, and a rotary valve 143 connected to the first tube 141, wherein the rotary valve 143 provides a valve port 144 such that the first tube 141 and the second tube 142 can communicate with each other. In addition, as shown in FIG. 2B, the rear sides of the slanted plate 11 and the arcuate plate 12 may provide a plurality of connecting pieces 122, and these connecting pieces 122 cooperate with connecting pieces 145 on the first tube 141 (For example, the connecting pieces 122 and the connecting pieces 145 can be connected together by securing elements, such as the screws. The manner for connecting the connecting pieces 122 with the connecting pieces 145 is not the main point of the present invention and thus is not described in detail here) such that the first tube 141 is securely fixed to the base 10.

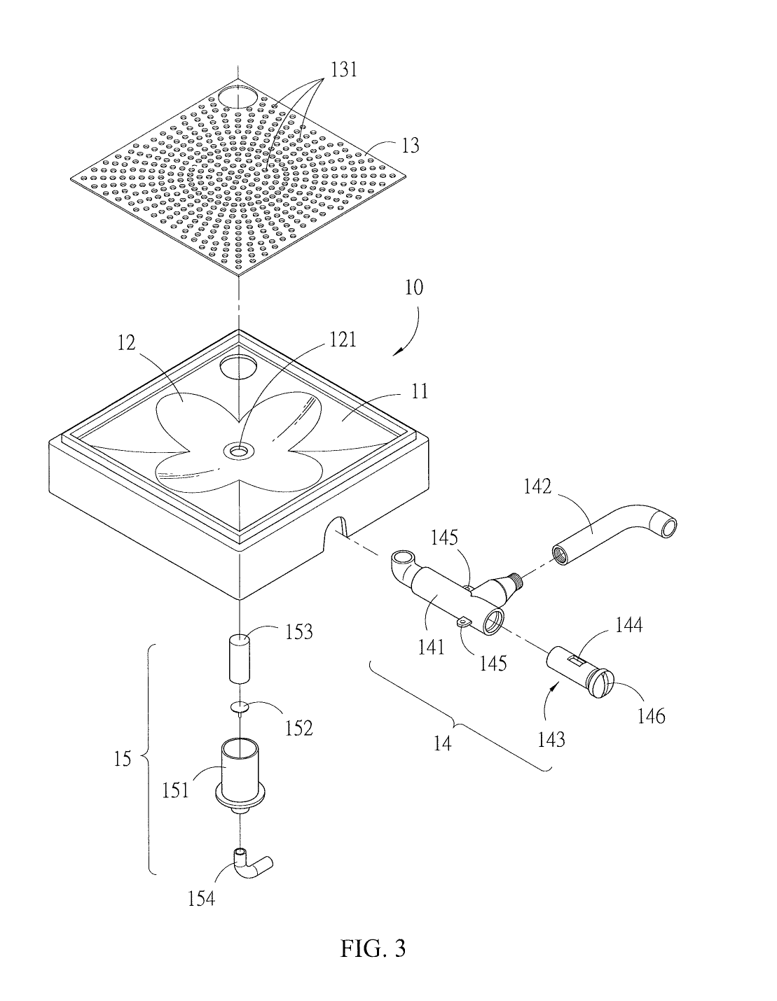

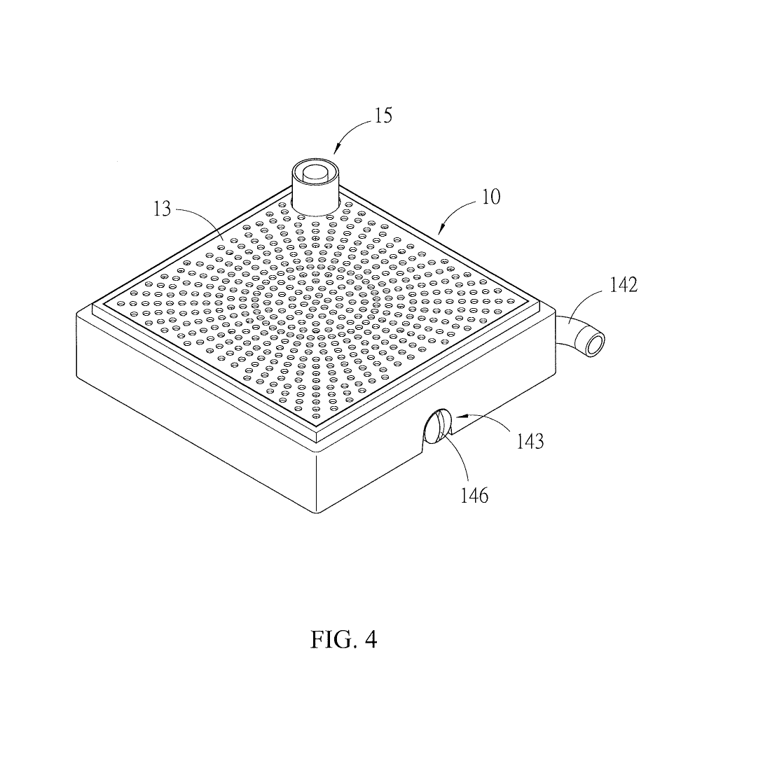

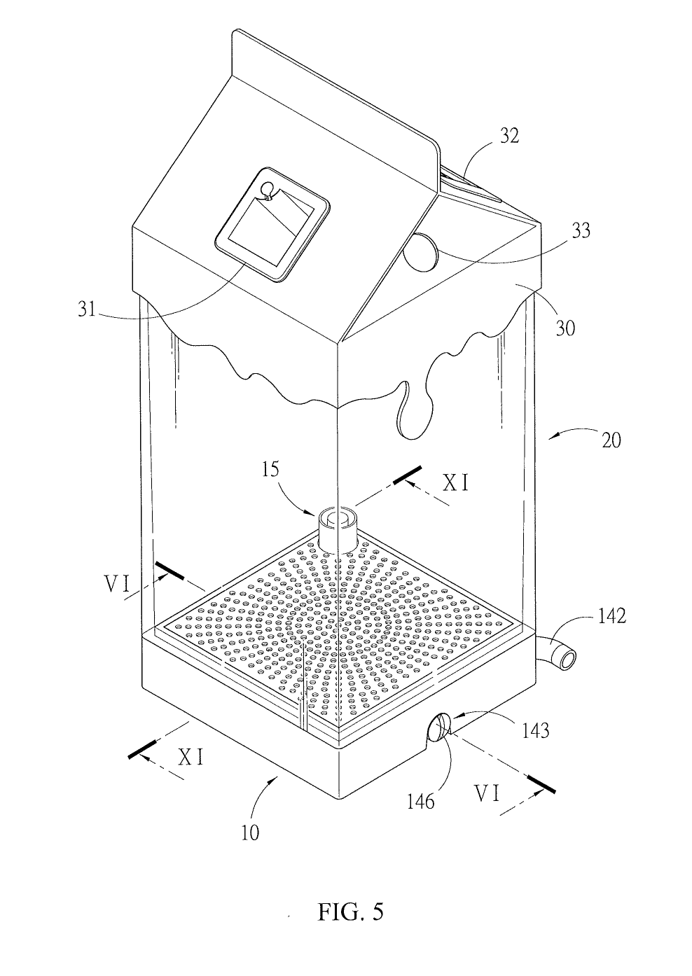

As shown in FIG. 3, an intake kit 15 may be optionally added into the dirt discharge structure of the present invention. The intake kit 15 comprises a housing 151 provided in the base 10 and extending through the slanted plate 11 and the barrier plate 13; an intake valve 152 provided within the house 151; an air stone 153 provided on the intake valve 152; and an intake tube 154 connected to the bottom of the housing 151. The perspective view, which shows the intake kit 15 being connected to the base 10, is shown in FIG. 4.

The dirt discharge structure provided by the present invention can be applied to a container. FIG. 5 shows a container 20 having the dirt discharge structure of the present invention. The dirt discharge structure can be connected to the bottom of the container 20 by high-frequency welding (but not limited to high-frequency welding). Further, the base 10 and the container 20 of the present invention are respectively presented as a rectangular body; however, they can be of different kinds of shapes such as ellipse, circle, triangle or polygon. The embodiments of the aforesaid shapes of the base 10 and the container 20 are not further described in the specification of the present application; however, they still can be covered by the claimed scope of the present invention.

The implementing manner of the dirt discharge structure of the present invention will be described below.

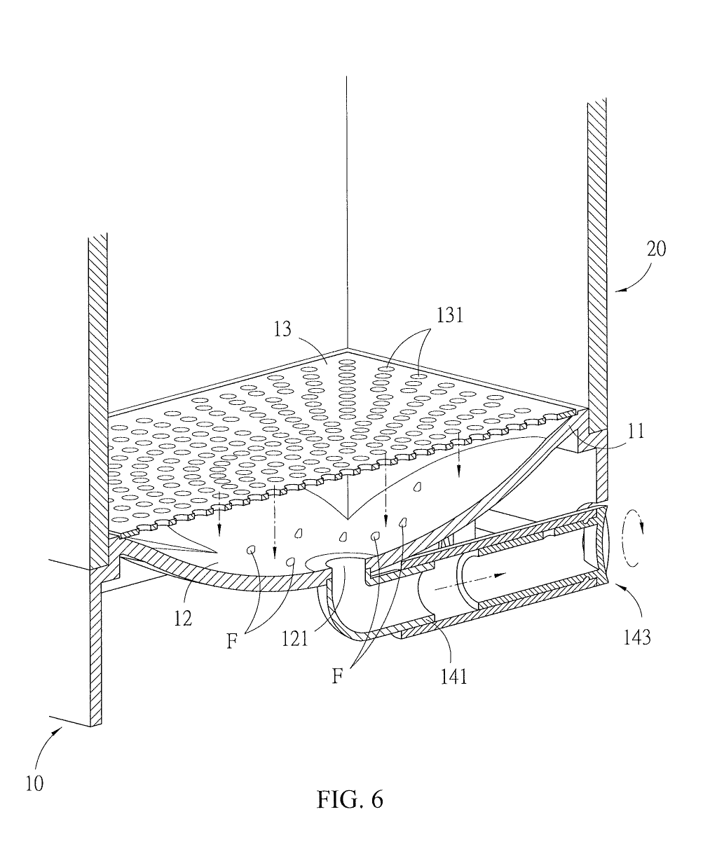

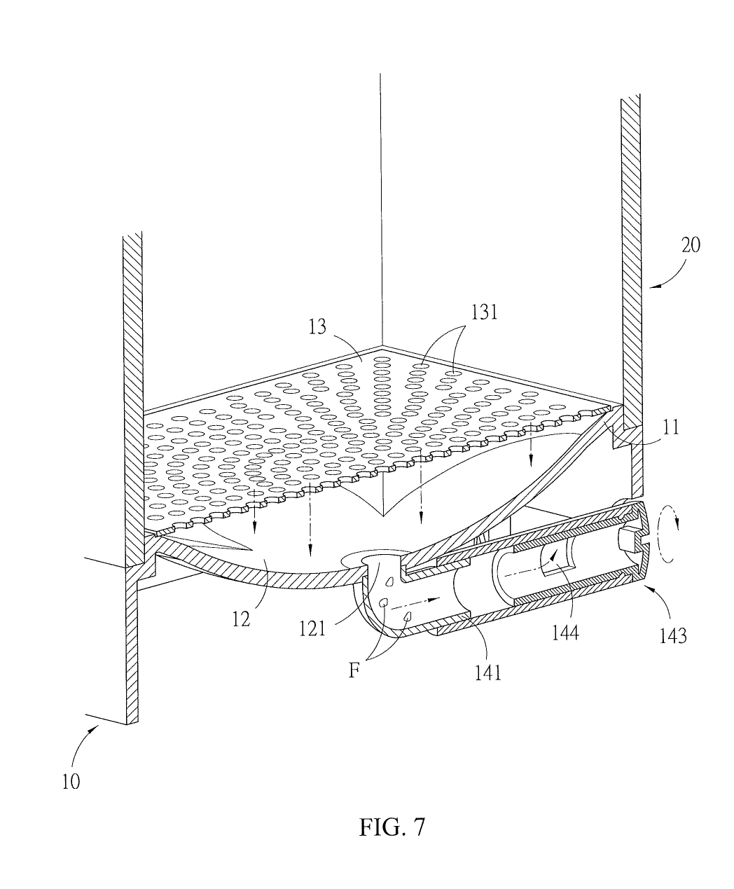

As shown in FIG. 6 which is a partial cross-sectional view taken along line VI-VI of FIG. 5. As stated above, one main purpose of the present invention is to solve the problem regarding the deposit of the filth in a fish tank. When the container 20 of the present invention is used for breeding the aquatic animals and the aquatic plants, the filth F (including residual feed and the waste of the fishes) falls on the slanted plate 11 and the arcuate plate 12 through the through-holes 131 on the barrier plate 13. Due to the arcuate shape of the arcuate plate 12 and the slanted plate 11, the arcuate plate 12 can be used as a gathering place for collecting the filth F. When a user desires to replace the water in the container 20, the user can just rotate the rotary valve 143 (Please also refer to FIG. 7) such that the valve port 144 on the rotary valve 143 is also rotated toward the second tube 142 which is connected to the first tube 141, and thus the foul water flows from the discharging hole 121 to the first tube 141 and further flows to the second tube 142 through the valve port 144 on the rotary valve 143 (Please refer to FIG. 3), and then the foul water is discharged from the base 10 of the dirt discharge structure through the second tube 142. Due to the arcuate plate 12 of the present invention, the foul water can flow along the slanted plate 11 toward the arcuate shape and flow to the discharging hole 121 (which is in the bottom of the arcuate plate 12), and thus the foul water can take the filth F (which is on the slated plate 11 and the arcuate plate 12) away (Please refer to the arrow direction of FIG. 5 and FIG. 6). Hence, the clean water then added into the container 20 (the water quantity of the added water is equal to the water quantity of the discharged water) will not be polluted by the filth F.

In addition, as shown in FIG. 4 and FIG. 5, for the convenience of operation and the aesthetics of the whole appearance of the container, the rotary valve 143 preferably aligns with the peripheral edge of the base 10 and one side of the rotary valve 143 is provided with a groove 146, and thus the rotary valve 143 can be rotated merely by the user's fingernail or an article (such as a coin) which abuts against the groove 146. Moreover, the second tube 142 is preferably connected at a right angle to one side of the first tube 141 (As shown in FIG. 2A) such that the rotary valve 143 is in one side of the base 10, and the second tube 142 used for discharging the foul water protrudes out of another side of the base 10 (the rear side of the base in this embodiment).

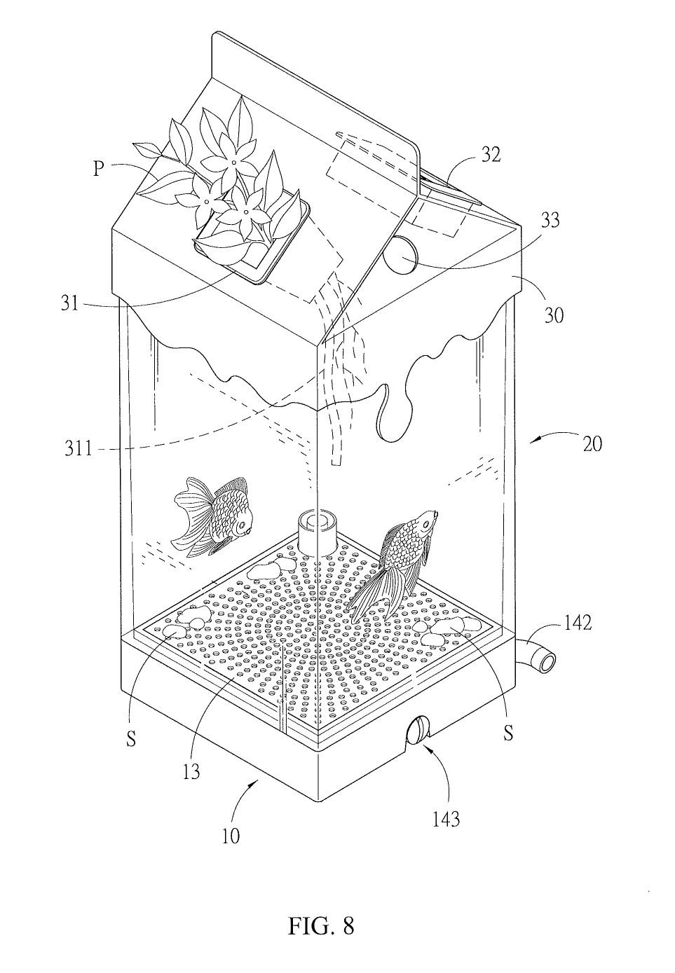

Please further refer to FIG. 8 which illustrates the container 20 for breeding the aquatic animals and the aquatic plants, the articles with larger volume (such as stones S) are supported by the barrier plate 13 so as to prevent these articles from falling on the arcuate plate 12 and blocking up the discharging hole 121. Further, FIG. 8 also shows the top of the container 20 comprising a cover 30. The edge of the cover 30 surrounding the top of the container 20 is presented as a drop-like shape such that the cover 30 can present an image of milk, and thus the whole appearance of this container presents a visual effect of milk box. Further, the cover 30 can be made of paper and the surface of the paper can be water repellent. Moreover, the cover 30 can further comprises at least one plant pot 31, at least one solar energy LED 32 or at least one opening 33. Aquatic plants P can be put into the plant pot 31 and one cotton thread 311 extends from the plant pot 31 to the container 20 such that the aquatic plants P can absorb the water in the container 20. The solar energy LED 32 can be utilized to illuminate and can emit light in a variety of colors to match the environment. The opening 33 on the cover 30 can be used as a feeding hole and the user can directly put the feed into the container 20 through the opening 33 for feeding the aquatic animals.

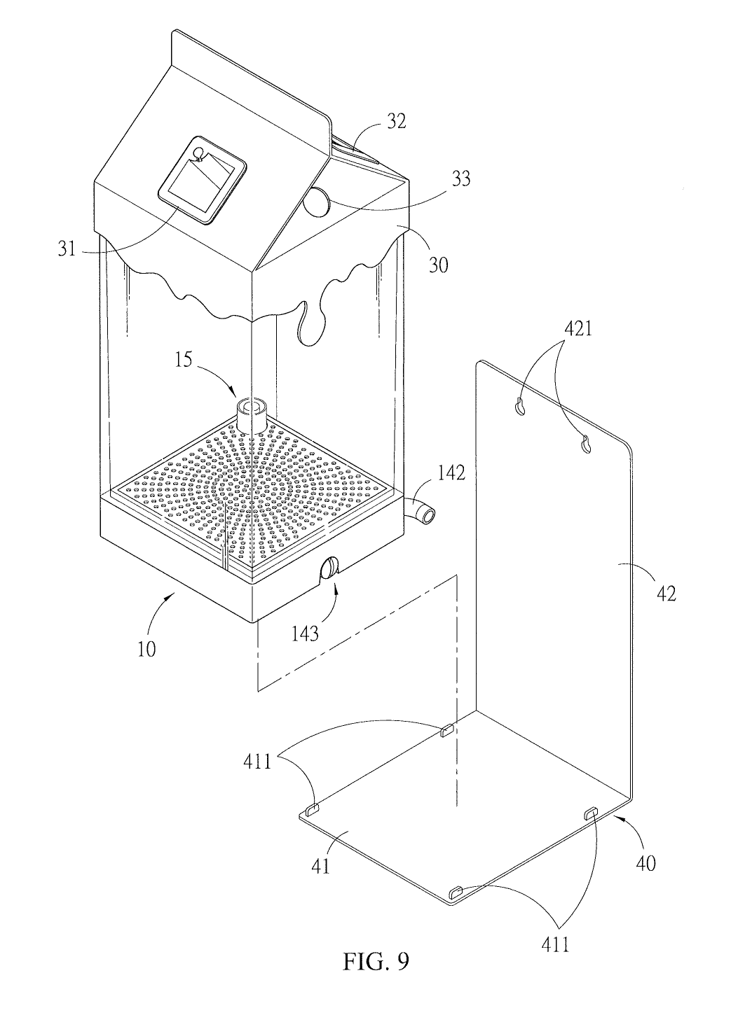

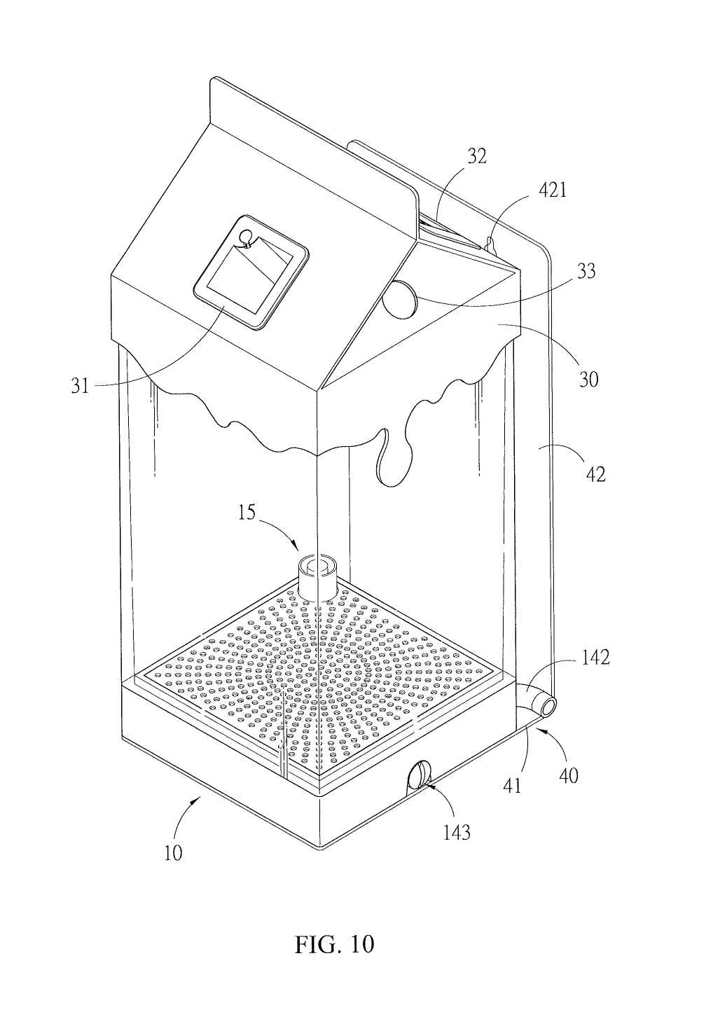

Please refer to FIG. 9, the present invention further provides an L-shaped wall board 40, the board comprising a flat panel 41 and a side plate 42, the side plate 42 connected to the flat panel 41 vertically (in the embodiment of the present application, the side plate 42 fixed to the flat panel 41 vertically), wherein the bottom of the base 10 is connected to the flat panel 41. In the embodiment of the present invention, the flat panel 41 comprises a plurality of protrusions 411 (as shown in FIG. 9, there are four protrusions 411 in this embodiment) and these protrusions 411 protrude upwardly from the top surface of the flat panel 41 such that the flat panel 41 can be fitted into the bottom of the base 10. Hence, the base 10 can be steadily placed on the wall board 40 (as shown in FIG. 10). In addition, the side plate 42 of the wall board 40 comprises a plurality of hanging holes 421. The wall board 40 can be hung on a variety of walls by these hanging holes 421 and the container together with the base 10 fixed onto the flat panel 41 can form a decoration which can be hung on the wall. Further, by cooperating with the solar energy LED 32 on the cover 30 (as shown in FIG. 8), the present invention can also be used as a wall lamp.

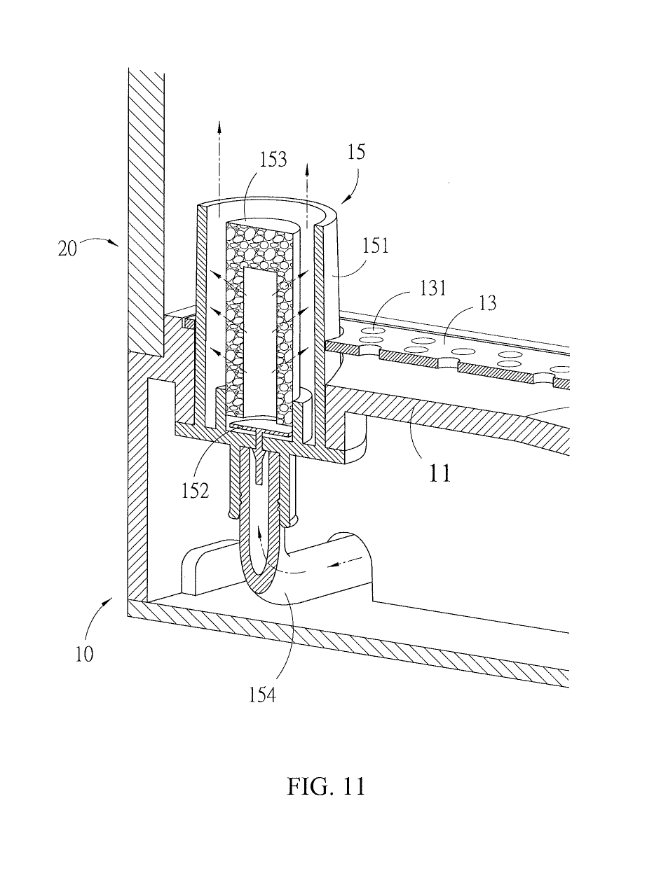

Please refer to FIG. 11, the intake kit 15 is utilized to pump the air into the container 20 by a pump (not shown) and increase the dissolved oxygen in the water of the container 20. The pump can pump the air into the housing 151 through the intake tube 154 and the intake valve 152 is moved upwardly by the pushing of air such that the air can be pumped into the air stone 153 and be dispersed into the container 20 through the air stone 153. The intake valve 152 will move downwardly and abut against the bottom of the housing 151 when the pump does not pump the air so as to avoid the backflow (i.e., flowing to the pump) of the water within the container 20 through the intake tube 154.

Please refer to FIG. 10, as stated in the aforesaid section [0033] of this specification, the rotary valve 143 of the present invention is provided in one side of the base 10 and the second tube 142 protrudes from the rear side of the base 10. Further, the intake tube 154 of the intake kit 15 also protrudes from the rear side of the base 10 and the side plate 42 (which is at the back of the base 10) can shelter the tubes such as the second tube 142 and the intake tube 154 such that the whole appearance of the present invention is neat and in order.

In addition, a plurality of far-infrared powders can be intermixed into the base 10 and the barrier plate 13 whereby the base 10 and the barrier plate 13 can emit far-infrared rays to facilitate the purifying of the water within the container 20 and can also be utilized to resist the bacterium, increase the temperature and inhibit the growth of the alga and thus can improve the ecological environment for the aquatic animals and the aquatic plants in the container 20.

What is claimed is:

1. A dirt discharge structure, comprising:
a base including a slanted plate extending inwardly from a peripheral edge of a top of the base toward a bottom of the base, an arcuate plate extending inwardly from an inner peripheral edge of the slanted plate toward the bottom of the base, and a discharging hole provided at the bottom of the arcuate plate;
a barrier plate provided on the top of the base, and a plurality of the through-holes provided on the barrier plate; and
a tube kit including:
a first tube provided beneath the arcuate plate and connected to the discharging hole,
a second tube connected to one side of the first tube, and
a rotary valve connected to the first tube used for communicating with the first tube and the second tube.

2. The dirt discharge structure according to claim 1, further comprising an intake kit provided in the base and extending through the slanted plate and the barrier plate.

3. The dirt discharge structure according to claim 2, wherein the intake kit comprises a housing provided in the base and extending through the slanted plate and the barrier plate; an intake valve provided within the house;
an air stone provided on the intake valve; and an intake tube connected to the bottom of the housing.

4. The dirt discharge structure according to claim 1, wherein a plurality of far-infrared powders is intermixed into the base and the barrier plate.

5. The dirt discharge structure according to claim 2, wherein a plurality of far-infrared powders is intermixed into the base and the barrier plate.

6. The dirt discharge structure according to claim 3, wherein a plurality of far-infrared powders is intermixed into the base and the barrier plate.

7. A container having a dirt discharge structure according to claim 1, wherein the dirt discharge structure is provided at the bottom of the container; wherein the container comprises a cover at a top of the container; and wherein the cover further comprises at least one plant pot, at least one solar energy LED and at least one opening.

8. The container according to claim 7, further comprising an L-shaped wall board, the board comprising a flat panel and a side plate, the side plate connected to the flat panel vertically, wherein the bottom of the base of the dirt discharge structure is connected to the flat panel.

9. The container according to claim 8, wherein the flat panel comprises a plurality of protrusions and the protrusions are fitted into the bottom of the base.

10. The container according to claim 8, wherein the side plate comprises a plurality of hanging holes.

11. The container according to claim 9, wherein the side plate comprises a plurality of hanging holes.
